(19) United States
(12) Patent Application Publication
(10) Pub. No.: US 2025/0224606 A1
(43) Pub. Date: Jul. 10, 2025

(54) IMPROVEMENTS IN OR RELATING TO OPTICAL IMAGING SYSTEMS

(71) Applicant: JSC YUKON ADVANCED OPTICS WORLDWIDE, Vilnius (LT)

(72) Inventor: Aliaksandr ALSHEUSKI, Vilnius (LT)

(21) Appl. No.: 18/854,691

(22) PCT Filed: Apr. 4, 2023
(86) PCT No.: PCT/EP2023/058893

§ 371 Date: Oct. 7, 2024

(30) Foreign Application Priority Data
Apr. 5, 2022 (GB) 2204953.0

(51) Int. Cl. G02B 23/12; F41G 1/38; G02B 23/16

(52) U.S. Cl. CPC G02B 23/12; F41G 1/38; G02B 23/16

(57) ABSTRACT

An optical imaging system is usable in connection with projectile weapons, for example for hunting or target shooting. The optical imaging system has a sighting device configured to obtain images in a first wavelength band. Further, it has a secondary imaging device that is configured to obtain images in a second wavelength band, the second wavelength band being different from the first wavelength band. The optical imaging system further has a mounting element configured to mechanically attach the secondary imaging device to and align with the sighting device. The sighting device has a processing element and is configured to electronically link with the secondary imaging device. The sighting device is configured to display a composite image comprised of a first image obtained by the sighting device and a second image obtained by the secondary imaging device.

### TECHNICAL FIELD

The present disclosure relates to the field of optical imaging systems, and in particular an optical imaging system comprising a sighting device and a secondary imaging device.

### BACKGROUND

Sighting and observation devices are used in many applications and under many different circumstances. In particular, sighting devices are utilized in connection with projectile weapons, for example for hunting or target shooting. Sighting devices are typically designed to provide images within a particular wavelength range, e.g., visible light, infrared light or ultraviolet light. Sighting devices have different advantages dependent on the wavelength range in which they function. For example, sighting devices using visible light are less useful at night time. Sighting devices using infrared radiation are useful at night, but may have a comparatively low resolution.

Sighting devices using a combination of several wavelength ranges are known. However, such devices may have several disadvantages, including weight and additional bulk, which can render the projectile weapon and/or sighting device less convenient to use. Further, the additional functionality provided by such a sighting device may not be useful in more than a few situations. For example, if the combined sighting device is used mainly during daytime, being usable during night time may not be useful to the user. Additionally, providing a combined image to the user of such a sighting device may increase the complexity of the sighting device.

Therefore, there is a need for a sighting device which flexibly provides an expanded wavelength range. This enables the user to take advantage of an expanded wavelength range, but without requiring the user to carry and operate a needlessly bulky and complex sighting device.

### SUMMARY

The present disclosure concerns an optical imaging system, comprising a sighting device configured to obtain images in a first wavelength band; a secondary imaging device configured to obtain images in a second wavelength band, the second wavelength band being different from the first wavelength band; a mounting element configured to mechanically attach the secondary imaging device to and align with the sighting device, wherein: the sighting device is configured to electronically link with the secondary imaging device, and the sighting device is configured to display a composite image comprised of a first image obtained by the sighting device and a second image obtained by the secondary imaging device

The sighting device may be configured to electronically link with the secondary imaging device when the secondary imaging device is attached to the mounting element.

The mounting element may comprise an connection component configured to detect the presence of the secondary imaging device.

The sighting device may comprise a communications element to engage with a second communications element comprised in the secondary imaging device.

Either or both of the communications element or second communications element may comprise one or more of: a Bluetooth transceiver; a WiFi transceiver; an infrared communications element; or a RF transceiver.

Either or both of the communications element and the second communications element may be configured to detect the proximity or presence of the other of the second communications element and the communications element.

The sighting device may be configured to obtain images in a first wavelength band; and the secondary imaging device is configured to obtain images in a second wavelength band, the second wavelength band being different from the first wavelength band.

The sighting device may be a sighting scope for a projectile weapon. Further, the secondary imaging device may be a hand-held monocular.

The present disclosure further concerns a method for an optical imaging system, the imaging system comprising a sighting device and a mounting element, wherein the method comprises: linking a secondary imaging device electronically to the sighting device; displaying a composite image comprised of a first image obtained by the sighting device and a second image obtained by the secondary imaging device.

The step of linking may comprise: triggering a linking process; and completing the linking process. The step of triggering a linking process may comprise determining that the secondary imaging device is attached to the mounting element.

The step of triggering may comprise detecting, at either of the sighting device or the secondary imaging device, the proximity or presence of the other of the secondary imaging device or sighting device.

The step of completing the linking process may comprise establishing a communication session between the sighting device and the secondary imaging device. The communication session may be established by way of a WiFi communication protocol or a Bluetooth communication protocol.

The present disclosure further concerns a non-transitory computer readable medium including program instructions for causing an optical imaging system to perform the method as set out above.

The present disclosure further concerns an optical imaging system comprising one or more processing elements configured to implement the method as set out above.

### BRIEF DESCRIPTION OF THE DRAWINGS

Other features, purposes and advantages of the invention will become more explicit by means of reading the detailed statement of the non-restrictive embodiments made with reference to the accompanying drawings.

FIG. 1 shows a sighting system, for example for use with a firearm.

FIG. 2 shows schematically an optical imaging system in accordance with an aspect of the present disclosure.

FIG. 3 illustrates a method in accordance with an aspect of the present disclosure.

### DETAILED DESCRIPTION

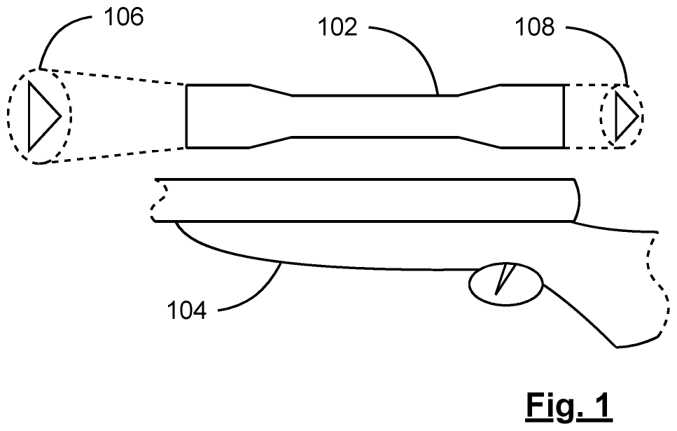

An example of a known sighting device will now be discussed with reference to FIG. 1.

The sighting device 102 is configured to be used with a firearm or other projectile weapon 104. Such sighting devices enable a user to aim and sight targets at longer ranges than would be possible using the naked eye of the user. A sighting device gathers radiation from a target area 106 and provides an image 108 to a user (not shown) in a known manner.

The sighting device 102 may use radiation in any suitable wavelength range. Typically, sighting devices use radiation in the visible wavelength spectrum. As visible radiation does not require conversion in order to be perceived by the user, such a sighting device does not require any electronic components to function. However, under circumstances wherein the levels of visible light are low or otherwise obscured, such a sighting device may not gather sufficient light to be usable. Sighting devices exist which are designed to gather enough visible light to be usable in low light situations, but these are very bulky and heavy due to the size of optical components required.

Sighting devices using non-visible radiation are known, which convert the invisible radiation, e.g., infrared radiation, into visible radiation. Such sighting devices, whilst usable in conditions where a sighting device based on visible light is not usable, have other limitations. For example, a sighting device operating at infrared wavelengths may be unusable in conditions where a significant amount of infrared radiation is present, which may render it impossible for a user to distinguish features of a target area.

In some cases, known sighting devices utilize radiation in several different wavelength bands. However, such sighting devices typically require a separate set of optical components for each wavelength band. This increases the weight and bulk of the sighting device.

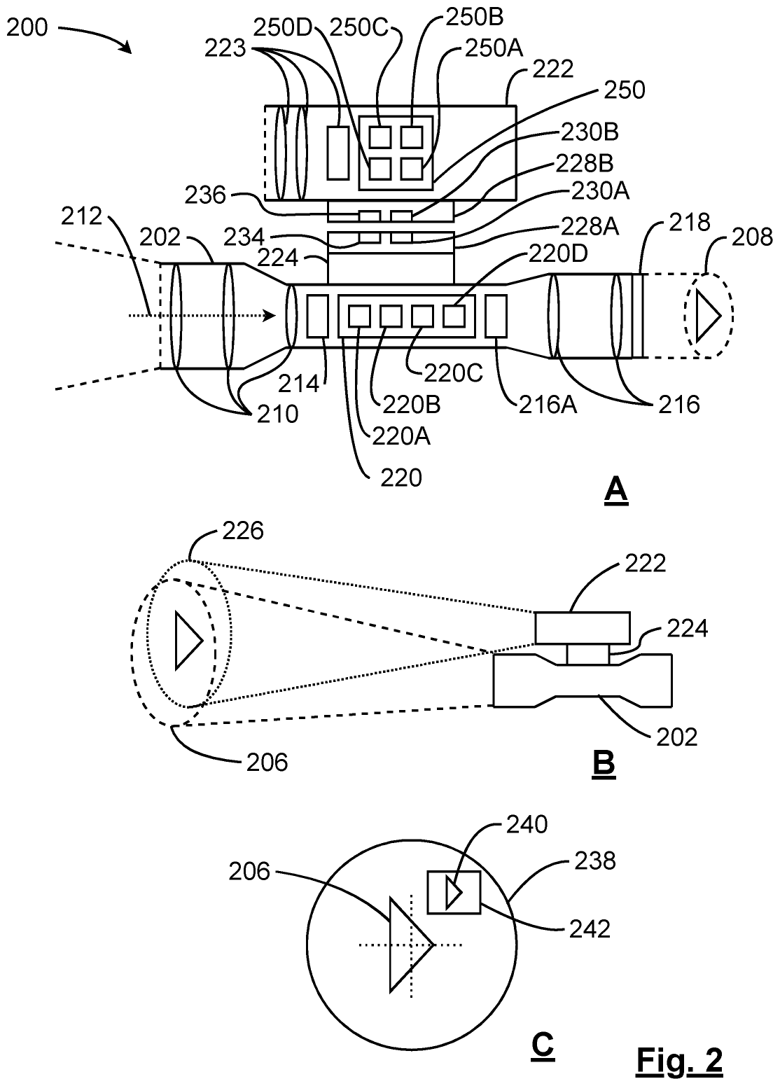

An exemplary optical imaging system will now be discussed with reference to FIG. 2.

The optical imaging system 200 comprises a sighting device 202 configured to obtain images in a first wavelength band. The sighting device may be any suitable type of sighting device. In some examples, the sighting device is a monocular scope for a projectile weapon, such as, without limitation, a rifle, a shotgun, a crossbow or an air rifle. Scope for projectile weapons are intended for aiding a user sighting the projectile weapon, and therefore comprise viewing and sighting aids (e.g., crosshairs or range indicators).

The sighting device may obtain images in any suitable wavelength band. Examples of wavelength bands include, but are not limited to: visible light; ultraviolet (UV); near infrared (NIR); short wave infrared (SWIR); medium wave infrared (MWIR); or long wave infrared (LWIR).

The sighting device comprises one or more optical elements 210 or components. The optical elements are used to gather input radiation 212 at an input end and to suitably process or transform the input radiation. In addition to the optical elements, the sighting device comprises a radiation sensor 214. The radiation sensor receives the input radiation that has propagated through and been processed by the optical elements. The radiation sensor may be any suitable sensor, including, but not limited to, a CMOS sensor, or a CCD sensor.

At an output end, the sighting device 202 comprises one or more optical output elements 216 that produce an output image 208 that is viewable by a user. In some examples, sighting device comprises an eye relief component 218 against which the user can rest their face or part thereof. The output image allows a user to see the target area 206 in a suitable manner, which in turn allows the user to use the apparatus (e.g., a rifle) to which the sighting device is attached.

The sighting device 202 may comprise any suitable number or types of optical output elements 216. In the present example, the sighting device comprises at least a display component 216A. The display component is connected to the radiation sensor 214 and to a processing component 220. The processing component is configured to process images received from the radiation sensor and provide them to the display component. The processing component may comprise any suitable elements or units, e.g., a central processing unit 220A, memory unit 220B and storage element 220C. The processing component may, in some examples, be used to perform additional processing. For example, the processing component may be used to perform image processing or may be used to temporarily store images obtained by the radiation sensor.

The processing component 220 additionally has a communication element 220D. The communication element is configured to communicate with external devices, e.g., a secondary imaging device 222 or other external devices (not shown).

It will be appreciated that the above description of the sighting device 202 and its components is intended to be illustrative only and should not be interpreted in a limiting manner. In particular, it will be appreciated that the number and types of components in a sighting device may be dependent on the wavelength or wavelength ranges in which the sighting device is intended to operate. For example, optical components used within the visible part of the electromagnetic spectrum differ in size, proportions and materials from optical components intended for use in a different part of the electromagnetic spectrum

The optical imaging system 200 further comprises a secondary imaging device 222 configured to obtain images in a second wavelength band, the second wavelength band being different from the first wavelength band. The secondary imaging device may be of a suitable type, including, without limitation: a monocular; binoculars; or an observation device.

The secondary imaging device 222 may be configured to obtain images in any suitable wavelength band. As discussed above, examples of wavelength bands include, but are not limited to: visible light; ultraviolet (UV); near infrared (NIR); short wave infrared (SWIR); medium wave infrared (MWIR); or long wave infrared (LWIR).

The secondary imaging device 222 may comprise any suitable components or elements. In the present example, the secondary imaging device comprises a number of optical components 223 that are configured to obtain images in the second wavelength band. Any suitable number or types of optical components may be comprised. It will be appreciated that the specific configuration of optical components in the secondary imaging device is dependent on the properties of the secondary imaging device as well as the properties of the second wavelength band. Some considerations have already been discussed above with reference to the sighting device 202, and will therefore not be repeated here for the sake of conciseness.

The secondary imaging device 222 may additionally comprise one or more functional elements or components. In the present example, the secondary imaging device comprises a secondary processing component 250. The secondary processing component is configured to process images received from the optical components 223 of the secondary imaging device and to process them in a suitable manner. The secondary processing component may comprise any suitable elements or units, e.g., a central processing unit 250A, memory unit 250B, storage element 250C, and a communication module 250D. An exemplary implementation of the use of the secondary processing component 250 is described in more detail below.

The optical imaging system 200 comprises a mounting element 224 configured to mechanically attach the secondary imaging device 222 to and align with the sighting device 202. When the secondary imaging device is attached to the mounting element, it is aligned so as to provide an image of second target area 226 that is substantially similar to the target area 206 imaged by the sighting device 202. In some examples, the second target area is substantially identical to the target area. In other examples, the target area and the second target area overlap by a certain percentage.

The mounting element 224 may have any suitable shape or configuration. In some examples, the mounting element is integral to the sighting device 202. In other examples, the mounting element is configured to be permanently or removably attached to the sighting device.

In some examples, the mounting element 224 comprises a mechanical engagement portion 228A that is configured to engage with a corresponding engagement portion 228B on the secondary imaging element. Examples of such engagement portions include, without limitation: dovetail rails, Weaver rails, Picatinny rails, NATO Accessory rails, KeyMod rails; M-LOK rails; UIT rails; or Freeland rails. In other examples, the mounting element comprises a magnetic engagement portion.

The mounting element 228 may comprise a locking component 230A configured to secure the secondary imaging device 222 to the mounting element. This prevents the secondary imaging device from becoming accidentally detached from the mounting element during use. Additionally, it prevents the secondary imaging device from moving during use, thereby avoiding the secondary imaging device becoming misaligned. The locking component may be configured to secure the secondary imaging device in any suitable fashion. In some examples, the locking component is configured to engage with a corresponding locking component 230B positioned on the secondary imaging device.

The mounting element 224 may comprise one or more adjustment means (not shown) or components that allow the position and/or spatial orientation of the secondary imaging device 222 to be adjusted relative to the sighting device 202. This allows the position and/or spatial orientation of the secondary imaging device to be adjusted so as to maximize the overlap between the first and second target areas. The adjustment means may have any suitable form, including (without limitation) screws, knobs, ratchets, buttons or switches.

The sighting device 202 is configured to electronically link with the secondary imaging device 222. This is accomplished in a suitable fashion. In the present example, the sighting device comprises a connection component 234 configured to determine that the secondary imaging device 222 has been attached to the mounting element 224. Once determined, an electronic linking process may be initiated by the sighting device, e.g., by the processing component 220 of the sighting device. This will be described in more detail in a following example.

The connection component 234 may be any suitable component or element. The connection component may be positioned in a suitable or advantageous location. In some examples, the connection component is positioned on the sighting device 202. In other examples, the connection component is positioned on the mounting element 224. In some examples, the position of the connection component is chosen in dependence on the type, properties or configuration of the connection component. For example, if the connection component is configured to detect physical proximity or contact, it is positioned so as to be in contact with a corresponding feature of the secondary imaging device when the secondary imaging device is attached to or mounted on the mounting element. In an example, the connection component is positioned in proximity to or forms part of a locking component 230A of the mounting element. In an illustrative example, the connection component is a mechanical switch that is triggered when the locking mechanism of the locking component is engaged.

Examples of suitable connection components 234 include, but are not limited to: a contact sensor; a switch; a latch; an indicating feature; an NFC chip; an electrical contact; a strain gauge; an optical sensor; a Bluetooth transceiver; or a manually operated switch.

In some examples, the connection component 234 is configured to cooperate or interact with another component in order to function. In the present example, the connection component is configured to communicate with a second connection component 236, which is positioned on the secondary imaging device. It will be appreciated that the type, configuration and properties of the second connection component, in some examples, is dependent on the configuration, properties or type of the connection component. In some examples, the connection component and/or the second connection component forms part of a locking mechanism configured to ensure that the secondary imaging device is removably locked into engagement with the mounting element. In an example, the connection component and the second connection component forms part of the respective mechanical engagement portions on the mounting element and the secondary imaging device. In a specific example, the second connection component is part of a second locking component 230B on the secondary imaging device that is configured to engage with a locking component 230A on the mounting element 224 to secure the secondary imaging device 222 to the mounting element. When the locking component and second locking component engage, the connection component similarly engages with the second connection component to indicate that the secondary imaging device is correctly mounted.

The connection component 234 is connected in a suitable manner to the processing component 220 of the sighting device 202. This allows the connection component to transmit signals to the processing component. In particular, the connection component transmits a signal to the processing component when it is detected that the secondary imaging device is correctly attached and when it is detected that the secondary imaging device is detached. In some examples, the connection component is connected to the processing component by way of a wired connection. In some examples, the connection component is connected to the processing component by way of a wireless connection.

Whilst described as a separate component to the communication element 220D above, it will be appreciated that, in some examples, the connection component 234 is effectively formed as part of the communication element of the sighting device 202. For example, in situations where the communication element 220D comprises a short-range communication means, it can be determined that the secondary imaging device 222 is connected to the sighting device when communication between the communication component 220D and the second connection component 234 is enabled.

The sighting device is configured to display a composite image 238 comprised of the image 208 obtained by the sighting device 202 and a second image 240 obtained by the secondary imaging device.

The composite image 238, in the present example, comprises either of the image or the second image superimposed on the other of the image or the second image. This allows the user to make use of the superimposed image 242 (or ‘secondary image’) as a reference and to compare with the primary image displayed to the user. For example, if the primary image uses visible light, the secondary image could use Near Infrared (NIR) light. In this example, a user could be viewing a target area with visible light and can use the superimposed image to check for the presence of things that are hidden behind features in the target area, e.g., an animal hiding in or behind plants or shrubs. A number of beneficial combinations of wavelength ranges will be apparent to the skilled reader.

Superimposing one image onto another, rather than combining the said images, reduces the computational burden in the sighting device 202. Further, it allows a secondary imaging device 222 to be mounted without requiring a lengthy calibration and alignment process. Rather, it is only required that a sufficient overlap between the first target area and the second target area can be established. Since there is no need to ensure perfect alignment between the sighting device and the secondary imaging device, changing or mounting the secondary imaging device is facilitated. A user can easily and quickly attach or change the secondary imaging device in dependence on the circumstances. Purely by way of example, if the sighting device utilizes visible light and the conditions have deteriorated such that the sighting device does not function to an acceptable degree, the user can attach the secondary imaging device to the sighting device and obtain the benefit of the imaging of the secondary imaging device.

The secondary image 242 may have any suitable size, format and position within the primary image. In some examples, the user may change the size and/or location of the secondary image within the primary image.

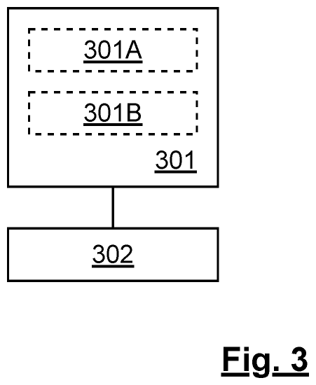

A method of linking a sighting device and a secondary imaging device will now be discussed with reference to FIG. 3. The exemplary method may, for example, be implemented in an optical imaging system such as discussed with reference to FIG. 2 above. Purely for exemplary purposes, reference will be made, where relevant, to elements of the device shown in FIG. 2.

In a first step 301, a secondary imaging device 222 is linked electronically to a sighting device 202. The linking step may be performed in any suitable fashion and by way of a suitable mechanism. In some examples, the linking step comprises a single linking operation. In other examples, the linking step comprises a plurality of linking sub-steps. For illustrative purposes a number of exemplary sub-steps will be described in the present example, although it will be understood that these for exemplary purposes only.

In a first sub-step 301A, a linking process is triggered. The linking process may be triggered in any suitable fashion. In some examples, the linking process is triggered by way of a user input, e.g., a user operating a switch or other control. In other examples, the linking process is triggered automatically. In the illustrative example, the linking process is triggered by a connection component 234 engaging with a second connection component 236. The connection components engage with each other at a suitable point, such as when the secondary imaging device 222 is correctly attached to the mounting component 224. In a specific example, where the connection component and the second connection component form part of the respective locking components, the connection components mutually engage when the locking components engage.

In another example, the linking process is triggered by either of the sighting device or the secondary imaging device detecting the proximity or presence of the other of the secondary imaging device or sighting device.

In other examples, the trigger for the linking process is dependent on whether it is the first time or a subsequent time that the sighting device and the secondary imaging device are linked. As an illustrative example, the sighting device and the secondary comprise communication components that contain Bluetooth transceivers. To trigger an initial linking process, the user initiates a pairing operation. Once paired, subsequent linking processes may be triggered by the sighting device or the secondary imaging device detecting the proximity of the other device.

In a second sub-step 301B, the linking process is completed. The linking process may be completed in a suitable manner. It will be appreciated that the linking process may be dependent on the type and/or properties of the linking protocol used to link the sighting device and the secondary imaging device.

In the present example, the sighting device 202 comprises a processing component 220 and the secondary imaging device 222 comprises a secondary processing component 250. In the second sub-step the communication component 220D of the sighting device communicates with the communication component 250D of the secondary imaging device to initiate and set up a communication or data transfer session therebetween. The communication or data transfer session may be set up using any suitable protocol or technology. In one example, the session is set up by way of Bluetooth. In another example, the session is set up by way of a WiFi communication protocol. It will be appreciated that the choice of protocol in some examples is dependent on the properties of the respective communication components of the sighting device and the secondary imaging device. A number of protocols and technologies exist in the field of short range communications, and these will for purposes of conciseness of the present disclosure not be discussed in more detail.

It will be noted that, whilst discussed in terms of wireless connection protocols, in principle, the communication session could equally well be performed by way of a wired connection between the sighting device and the secondary imaging device.

It will also be noted that, whilst described as two distinct sub-steps, the triggering and completion sub-steps could equally well be performed as a singular operation. It will be appreciated that the specific implementation is dependent on one or more of: the properties of the sighting device; the properties of the secondary imaging device; the properties of the processing component of the sighting device; the properties of the processing component of the secondary imaging device; properties of protocols, firmware, software, software applications implemented or running on the sighting device; or properties of protocols, firmware, software, software applications implemented or running on the secondary imaging device.

In a second step 302, a composite image is displayed to the user, the composite image being comprised of a first image obtained by the sighting device and a second image obtained by the secondary imaging device.

The display step may be performed in a suitable fashion. In some examples, the display step is performed by the processing component 220 and the display component 216A of the sighting device 202 working in conjunction to provide the composite image to the user. In a specific example, the composite image is displayed to the user by way of the display component 216A and optical output elements 216 of the sighting device 202.

It will be appreciated that, as part of the method, a number of administrative or functional steps may be carried out by the processing component 220. Examples including, but are not limited to: formatting; encoding; extracting; moving; copying; encrypting or resizing.

It will be understood that various modifications and/or improvements obvious to the person skilled in the art may be made to the various embodiments of the invention described in the present description without departing from the scope of the invention defined by the appended claims.

1. An optical imaging system, comprising
a sighting device configured to obtain images in a first wavelength band;
a secondary imaging device configured to obtain images in a second wavelength band, the second wavelength band being different from the first wavelength band;
a mounting element configured to mechanically attach the secondary imaging device to and align with the sighting device, wherein:
the sighting device is configured to electronically link with the secondary imaging device, and
the sighting device is configured to display a composite image comprised of a first image obtained by the sighting device and a second image obtained by the secondary imaging device.

2. An optical imaging system according to claim 1, wherein the sighting device is configured to electronically link with the secondary imaging device when the secondary imaging device is attached to the mounting element.

3. An optical imaging system according to claim 2, wherein the mounting element comprises an connection component configured to detect the presence of the secondary imaging device.

4. An optical imaging system according to claim 2 or 3, wherein the sighting device comprises a communications element to engage with a second communications element comprised in the secondary imaging device.

5. An optical imaging system according to claim 4, wherein either or both of the communications element or second communications element comprises one or more of: a Bluetooth transceiver; a WiFi transceiver; an infrared communications element; or a RF transceiver.

6. An optical imaging system according to claim 5, wherein either or both of the communications element and the second communications element is configured to detect the proximity or presence of the other of the second communications element and the communications element.

7. An optical imaging system according to any of claims 1 to 5, wherein:
the sighting device is configured to obtain images in a first wavelength band; and
the secondary imaging device is configured to obtain images in a second wavelength band, the second wavelength band being different from the first wavelength band.

8. An optical imaging system according to any of claims 1 to 7, wherein the sighting device is a sighting scope for a projectile weapon.

9. An optical imaging system according to claim 8, wherein the secondary imaging device is a hand-held monocular.

10. A method for an optical imaging system, the imaging system comprising a sighting device and a mounting element, wherein the method comprises:
linking a secondary imaging device electronically to the sighting device;
displaying a composite image comprised of a first image obtained by the sighting device and a second image obtained by the secondary imaging device.

11. A method according to claim 10, wherein the step of linking comprises:
triggering a linking process; and
completing the linking process.

12. A method according to claim 11, wherein the step of triggering a linking process comprises determining that the secondary imaging device is attached to the mounting element.

13. A method according to claim 11, wherein the step of triggering comprises detecting, at either of the sighting device or the secondary imaging device, the proximity or presence of the other of the secondary imaging device or sighting device.

14. A method according to any of claims 11 to 13, wherein the step of completing the linking process comprises establishing a communication session between the sighting device and the secondary imaging device.

15. A method according to claim 14, wherein the communication session is established by way of a WiFi communication protocol or a Bluetooth communication protocol.

16. A non-transitory computer readable medium including program instructions for causing an optical imaging system to perform the method of any of claims 10 to 15.

17. An optical imaging system comprising one or more processing elements configured to implement the method of any of claims 1 to 15.
